(19) United States
(12) Patent Application Publication
(10) Pub. No.: US 2006/0198424 A1
(43) Pub. Date: Sep. 7, 2006

(54) Probe structure for an ear thermometer

(76) Inventors: Kun-Sung Chen, San-Chung (TW); Ying-Chao Lin, San-Chung (TW); Hsing Ouyang, San-Chung (TW); Yao Ouyang, San-Chung (TW); Kuo-Hung Huang, San-Chung (TW); Chiu-Jung Lin, San-Chung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/068,788

(22) Filed: Mar. 2, 2005

(51) Int. Cl. G01K 1/00; G01J 5/00

(52) U.S. Cl. 374/208; 374/121

(57) ABSTRACT

A probe structure for an ear thermometer includes a housing, a sleeve component, a sensor unit and a holding component. The housing has a first containing room to contain the sleeve component having a second containing room. The sleeve component has a front end formed with a reflective surface. The sensor unit is placed inside the second containing room and has a window, via which the sensor unit detects heat radiation. The sleeve component is used to lower heat radiation impact upon the sensor unit and prevent inexact measurements by the sensor unit caused by detecting objects other than the measured object. The sleeve component helps to reflect heat radiation from the measured object to the infrared sensor. This sensor unit functions well even though it is not disposed at the front most end of the probe. The holding component has one end against the bottom of the sensor unit.

### BACKGROUND OF THE INVENTION

1. Field of the Invention The present invention is related to a probe structure for an ear thermometer and, more particularly, to a probe for an infrared thermometer for measuring the temperature of a human ear.

2. Description of Related Art

Nowadays, people are not satisfied with conventional contact-type thermometers, such as mercury thermometers or electronic thermometers. They desire exacter, speedier, easy to measure, easy to read, harmless and non-invasive temperature-measuring devices or methods. At present, non-contact infrared thermometers meet the foresaid requirements. Hence, people are willing to pay more for and are more interested in this kind of thermometer, so various kinds of infrared thermometers have been developed over time.

In general, an infrared thermometer has a probe projected therefrom. One can place the probe in an external ear canal to measure a person's temperature. The probe has an infrared sensor and a waveguide. Therein, the waveguide is used to pass the infrared rays radiated from the external ear canal or eardrum to the infrared sensor.

Reference is made to FIG. 1, which is a cross-sectional view of a probe of a conventional infrared thermometer. The probe 10 is composed of a hollow cylinder with a conoid shape. The end of the probe 10 having the greater diameter is fixed onto the main body of the thermometer 12 and has an infrared sensor 104 disposed therein. The surface of the infrared sensor 104 used for detection has a waveguide 106 attached thereon. The waveguide 106 is cylindrical and has an end extended to the end of the probe 10 having a smaller diameter (i.e. the end of the thermometer close to the object ready for measurement).

The infrared sensor 104 further has an environmental temperature sensor 108, which is used to measure the temperature of the infrared sensor 104. During temperature measurement, the infrared sensor 104 can determine the temperature difference between itself and the object being measured by detecting the infrared rays radiated from the object. Thus, the real temperature of the object can be known by adding up the temperature of the infrared sensor 104 itself and the temperature difference obtained by the infrared sensor 104.

However, if a temperature difference occurs between the waveguide 106 and the infrared sensor 104, the temperature measured by the thermometer will be erroneous. In order to avoid this, the waveguide 106 is usually made of a metal with high thermal conductivity. It is common to make the internal surface of the waveguide 106 smooth and place a gold-plated layer thereon.

During temperature measurement, the probe 10 is placed inside a human's external ear canal. Unavoidably, parts of the external surface of the probe 10 may contact with the external ear canal. Since the temperature of the probe 10 is generally lower than that of the external ear canal, the heat of the external ear canal will be passed to the probe 10. Subsequently, heat will be passed to the waveguide 106 via the probe 10 causing the temperature of waveguide 106 to rise slightly. As a result, the measurement of the infrared sensor 104 will be affected by the waveguide 106 and become erroneous.

Reference is made to FIG. 2. In order to overcome the foresaid problem, a tubular pipe 102 is provided between the waveguide 106 and the probe 10. The tubular pipe 102 provides heat isolation between the waveguide 106 and the probe 10 and is made of a material with good thermal conductivity. Via the heat isolation, measurement errors can be minimized.

However, if the waveguide 106 transmits heat to the infrared sensor 104, it will cause energy loss in the heat transmission. Thus, the measurement result of the sensor must be different from the true temperature. Any effort to improve the measurement only succeeds in making the error smaller, not in actually obtaining an accurate result.

As such, another kind of infrared thermometer has been developed. It has a sensor unit 20 that can directly detect the heat radiation of the measured object. Thus, the loss caused by the heat transmission in the inter-media and the measurement result can become lower. On the other hand, omitting the waveguide can lower the cost of the thermometer. For manufacturing the foresaid thermometer, the sensor unit 20 is disposed inside the probe 10 to detect the temperature of the object ready for measurement. This kind of thermometer is characterized in that the sensor unit 20 is positioned at a place for direct detection of heat radiation of the measured object. In this way, the waveguide disposed between the sensor unit 20 and the measured object for transmission can be omitted. The sensor unit 20 includes an infrared sensor and an environmental temperature sensor (not shown). These two sensors are disposed on a sensor base 22 with good heat isolation. The sensor base 22 is surrounded by a heat-dissipating component 24 installed inside the probe 10.

However, if the senor unit 20 is placed in the front most end, some drawbacks, as listed below, are caused:
(1) The sensor unit 20 is easily impacted by radiative heat from the measured object;
(2) The sensor unit 20 is easily impacted by heat from the measured object transmitted via air;
(3) The sensor unit 20 may contact the measured object and a contact-type heat transmission may be caused; and
(4) The mirror surface of the sensor unit 20 is easily smeared making the measurement inexact.

Accordingly, as discussed above, the prior art still has some drawbacks that could be improved upon. The present invention aims to resolve the drawbacks in the prior art.

### SUMMARY OF THE INVENTION

An objective of the present invention is to provide a probe structure for an ear thermometer. In particular, the present invention improves the design of the probe. In the present invention, the sensor unit is moved inward and a sleeve component is provided in front of the sensor unit. The sleeve component is used to help the sensor unit function well even though the sensor unit is not disposed at the front most end of the probe.

The present invention uses the sleeve component to reflect the heat radiation from the measured object to the infrared sensor. Furthermore, the present invention uses the sleeve component to prevent an inexact temperature measurement being taken by the sensor unit caused by detecting heat from other objects, such as the plastic portion of the probe, besides the measured object. Moreover, using the sleeve component lowers the direct impact of heat radiation upon the sensor unit.

For reaching the objective above, the present invention provides a probe structure for an ear thermometer, including: a housing formed with a first containing room inside, the housing having a connecting portion and an inner wall, the connecting portion being formed between the first containing room and the inner wall; a sleeve component disposed inside the first containing room and having a second containing room, the sleeve component having a front end formed with a reflective surface and a opening being formed between the second containing room and the reflective surface, the sleeve component having an outer wall forming a connecting surface, the connecting surface being jointed with the inner wall of the housing, the connecting surface being formed with a projective edge, and the projective edge being jointed with the connecting portion of the housing; a sensor unit disposed inside the second containing room and having a shell, the shell having a front end with a window corresponding to the opening of the sleeve component, the sensor unit detecting heat radiation via the window; and a holding component having a holding body, the holding body having an end with a holding surface and another end jointed with the housing, the holding surface being against a bottom of the sensor unit.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a cross-sectional view of a probe of a conventional infrared thermometer;

FIG. 2 is a cross-sectional view of a probe of another conventional infrared thermometer;

FIG. 3 is still a cross-sectional view of a probe of another conventional infrared thermometer; and

FIG. 4 is a cross-sectional view of a probe of an ear thermometer in accordance with the present invention.

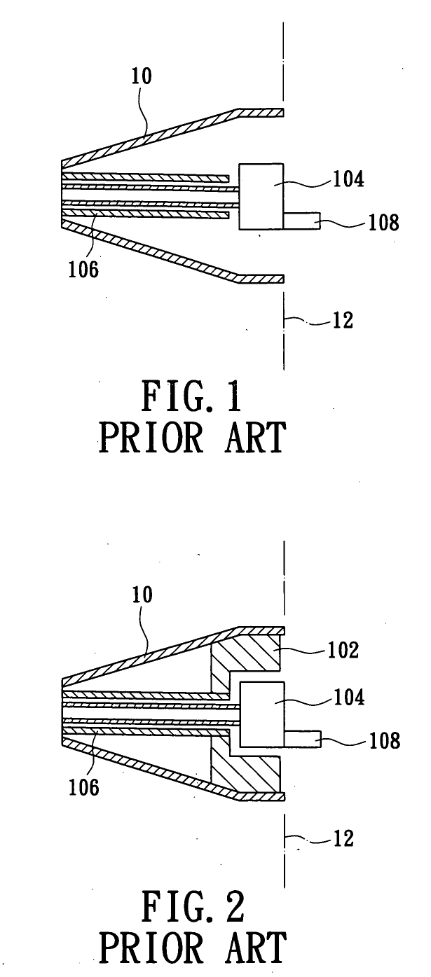

### DETAILED DESCRIPTION OF PREFERRED EMBODIMENTS

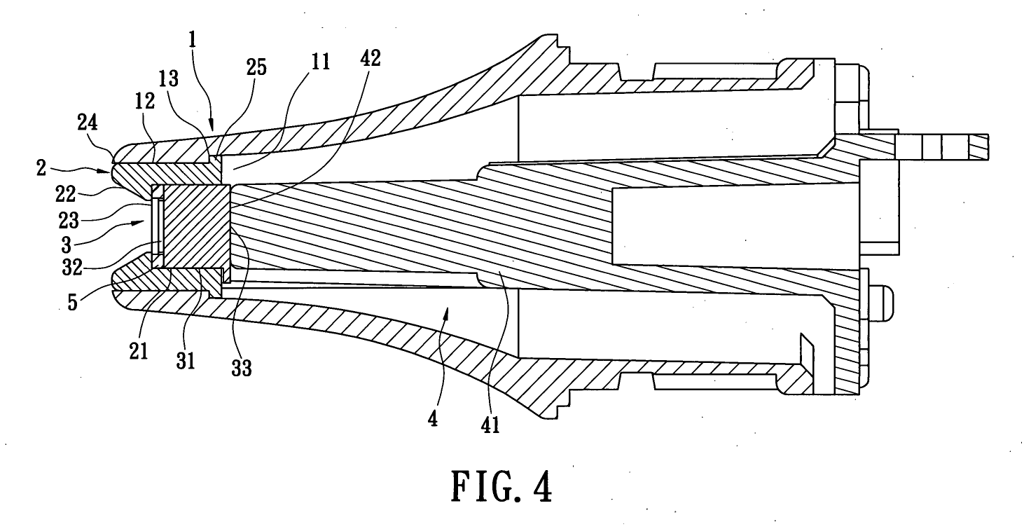

Reference is made to FIG. 4, which is a cross-sectional view of a probe of an ear thermometer in accordance with the present invention. It includes a housing 1, a sleeve component 2, a sensor unit 3 and a holding component 4.

The shape of the housing 1 is suitable to be placed inside a human's external ear canal so that the housing 1 can be inserted into the external ear canal during temperature measurement. The housing 1 is formed with a first containing room 11 inside and an opening at its front end, in which the opening is connected with the first containing room 11. The housing 1 has a connecting portion 13 formed between its inner wall 12 and the first containing room 11.

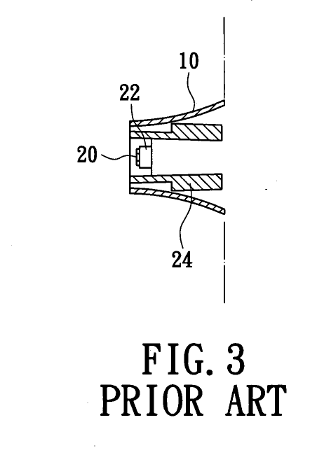

The sleeve component 2 is a hollow cylinder and combined with the housing 1 via an ultrasonic meld. In practice, the sleeve component 2 can also be combined with the housing via mold injection to form a partial structure for the housing 1. The sleeve component 2 is disposed in the first containing room 11 and located at the front end of the housing 1. The sleeve component 2 is formed with a second containing room 21 inside. A reflective surface 22 with a conical shape is formed inside the front end of the sleeve component 2. The reflective surface 22 is used to reflect the heat radiation to the sensor unit 3. Thus, using the reflective surface 22 of the sleeve component 2 helps the reception of the heat radiation of the measured object. Hence, even though the sensor unit 3 is not disposed at the front most end of the housing 1, it can still function well. Furthermore, the sleeve component 2 having the reflective surface 22 reduces the impact of the heat radiation to the sensor unit 3. Moreover, since the sleeve component 2 is disposed at the front most end of the housing 1, it prevents inexact temperature measurement by the sensor unit 3 caused by detecting other objects, such as the plastic portion of the probe shown in FIG. 3, besides the measured object. An opening 23 is formed between the reflective surface 22 and the second containing room 21. The outer wall of the sleeve component 22 forms a connecting surface 24 to joint with the inner wall 12. The connecting surface 24 is formed with a projective edge 25 to joint with the connecting portion 13.

The sensor unit 3 is disposed in the second containing room 21 of the sleeve component 2. The sensor unit 3 has a shell 31, which has a window 32 at its front end. The window 32 corresponds to the opening 23. Hence, the sensor unit 3 detects heat radiation from the measured object via the window 32. The sensor unit 3 has two sensors inside (not shown), including an infrared sensor and an environmental temperature sensor. These two sensors are combined together to improve the sensitivity and precision of temperature measurement.

The holding component 4 has a holding body 41, which has one end formed with a holding surface 42 and the other end connecting with the housing 1. The holding surface 42 is against the bottom 33 of the sensor unit 3 to hold the sensor unit 3 disposed inside the sleeve component 2.

The present invention further has a ring component 5, which is disposed inside the second containing room 21. The ring component 5 is located between the opening 23 and the front end of the shell 31 of the sensor unit 3. The ring component is an elastic body that is clamped between the opening 23 and the front end of the shell 31 of the sensor unit 3 to prevent water from entering the housing 1 via the opening 23. Hence, the ring component 5 can be used to provide waterproof functionality.

To sum up, the probe structure of the present invention has the following features: first, the sleeve component 2 of the present invention disposed at the front end of the housing 1 has a front end formed with a conical reflective surface 22. The reflective surface 22 can be used to reflect the heat radiation to the sensor unit 3. Hence, using the reflective surface 22 of the sleeve component 2 helps to receive the heat radiation from the measured object so that the sensor unit 3 still functions well even though it isn't placed at the front most end of the housing 1. Furthermore, the sleeve component 2 with the reflective surface 22 lowers the direct impact of the heat radiation to the sensor unit 3. The sleeve component 2 is disposed at the front most end of the housing 1 so that it prevents inexact temperature measurement by the sensor unit 3 caused by detecting other objects, such as the plastic portion of the probe shown in FIG. 3, besides the measured object.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A probe structure for an ear thermometer, comprising:
a housing formed with a first containing room inside, the housing having a connecting portion and an inner wall, the connecting portion being formed between the first containing room and the inner wall;
a sleeve component disposed inside the first containing room and having a second containing room, the sleeve component having a front end formed with a reflective surface and a opening being formed between the second containing room and the reflective surface, the sleeve component having an outer wall forming a connecting surface, the connecting surface being jointed with the inner wall of the housing, the connecting surface being formed with a projective edge, and the projective edge being jointed with the connecting portion of the housing;
a sensor unit disposed inside the second containing room and having a shell, the shell having a front end with a window corresponding to the opening of the sleeve component, the sensor unit detecting heat radiation via the window; and
a holding component having a holding body, the holding body having an end with a holding surface and another end jointed with the housing, the holding surface being against a bottom of the sensor unit.

2. The probe structure as claimed in claim 1, further comprising a ring component disposed inside the second containing room, the ring component being positioned between the opening of the sleeve component and the front end of the shell of the sensor unit.

3. The probe structure as claimed in claim 1, wherein the sleeve component is combined with the housing via an ultrasonic meld method.

4. The probe structure as claimed in claim 1, wherein the sleeve component is combined with the housing via mold injection.

5. The probe structure as claimed in claim 1, wherein the reflective surface is formed with a conical shape and located inside the front end of the sleeve component.
